(19) United States
(12) Patent Application Publication
(10) Pub. No.: US 2009/0060624 A1
(43) Pub. Date: Mar. 5, 2009

(54) Pen-Like Dispenser

(75) Inventors: Laurent Schenck, Feldkirch (AT); Frank Muller, Feldkirch (AT)

Correspondence Address: BOND, SCHOENECK & KING, PLLC, ONE LINCOLN CENTER, SYRACUSE, NY, 13202-1355, US

(73) Assignee: IVOCLAR VIVADENT AG, Schaan (LI)

(21) Appl. No.: 12/201,632

(22) Filed: Aug. 29, 2008

Related U.S. Application Data
(60) Provisional application No. 60/935,778, filed on Aug. 30, 2007.

(51) Int. Cl. B05C 17/01

(52) U.S. Cl. 401/171

(57) ABSTRACT

A dispenser includes: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; and an advancing mechanism constructed and configured to move the ejection mechanism within the tank. The dispenser further includes one or more features directed at improving the ergonomics, dispensing functionality and/or operation thereof, especially (but not exclusively) for such dispensers to be utilized in connection with dispensing dental materials.

### CROSS REFERENCE TO RELATED APPLICATIONS

This application claims priority to U.S. Patent Application No. 60/935,778, filed Aug. 30, 2007, which is hereby incorporated by reference.

### FIELD OF THE INVENTION

The present invention is directed to dispensers. The present invention is also directed to pen-like dispensers. The present invention is further directed to pen-like dispensers which may be filled with, and are suitably constructed for, dispensing dental materials. The present invention is also directed to methods, combinations, and subcombinations associated with the above.

### BACKGROUND OF THE INVENTION

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art.

U.S. Patent Application Publication No. US2007/0086830 discloses a conventional pen-like dispenser of a liquid, the contents of this Publication are incorporated herein by reference in their entirety. FIG. 1 is composite sectional view of the conventional liquid container described in the abovementioned Publication. In FIG. 1, a liquid container 10 generally includes a container body 12 having a tank section T that holds a liquid L for cosmetic, writing, medical use or oral case, an applicator 20 that is a liquid supply member mounted to the front of the container body 12, a piston 22 that is slidable through the tank section T, and a piston advancing mechanism 23 provided in the rear of the container body 12 to cause the piston 22 to be advanced forward.

The container body 12 includes a body case 14 which forms the tank section T and has a front end port 14a in a smaller diameter than that of the body case 14, and a tip element 16 that is integrally mounted on the outer circumference of the front end port 14a. The tip element 16 has a front end port 16c and an annular groove 16a that is formed in the front end surface radially outward from the front end port 16c. The annular groove 16a includes an outer circumferential surface provided with a female threaded portion 16b.

The applicator 20, which is a liquid supply member, has a rear end provided with a male threaded portion 20a to be threadedly engaged with the female threaded portion 16b of the tip element 16. The applicator 20 can be removed from the tip element 16 by disengaging the male threaded portion 20a from the female threaded portion 16b so that the applicator 20 is removable from the container body 12.

The liquid supply member may not only be a syringe type applicator as shown in the figure, but also a brush, a bar of non-woven material, or other member of any shape and configuration.

The liquid supply member can be removably mounted to the tip element 16 by a threaded engagement such as in this example, or by any other mounting structure including locking by fitting. The mounting structure of engagement or locking allows the liquid supply member to be easily removed from the tip element 16, and also prevents the liquid supply member from falling off from the tip element 16 while the liquid supply member is mounted to it. The applicator 20 can be removed from the front end of the tip element 16, which makes the removing easy with no liquid leaking.

When not in use, a cap 36 is removably attached to the tip element 16 to protect the applicator 20.

The piston advancing mechanism 23 comprises a piston rod 24 which has a front end coupled to the piston 22, and extends backward from the front end with a male threaded portion 24a along the circumferential surface thereof, and a piston rod guide 26 which has a front portion of the inner circumferential surface thereof in which a female threaded bore 26a is formed to be threadedly engaged with the male thread 24a of the piston rod 24, a stopper cylinder 27 through which the piston rod 24 passes in a non-rotatable manner relative to each other, a tail cap 28 coupled to the stopper cylinder 27, a rotating cam 30 mounted to the outer circumferential surface of the piston rod guide 26 in a non-rotatable manner relative to each other, a pushing member 32 projecting outward from the tail cap 28, and a return spring 34 to bias the rotating cam 30 backward. The pushing member 32 provides an operation member.

In use of the liquid container 10 of the above structure, the cap 36 is removed and the liquid is applied with the applicator 20, and in order to supply more liquid through the applicator 20, the pushing member 32 is pushed toward the container body 12. As described above, every time the pushing member 32 is pushed, the projections 30a of the rotating cam 30 rotates by the amount to move to the adjacent cam grooves 28b and the piston rod guide 26 integrally rotates. On the contrary, the piston rod 24 which is non-rotatable relative to the container body 12 does not rotate, which causes a relative rotation between the piston rod guide 26 and the piston rod 24, and the engagement between the female threaded bore 26a of the piston rod guide 26 and the male thread 24a of the piston rod 24 allows the piston rod 24 and the piston 22 to be advanced forward. As the piston 22 is advanced through the tank section T, the liquid L in the tank section T is forced toward the front end port 14a of the body case 14 to be supplied through the front end of the applicator 20 for use.

The liquid supply member, that is the applicator 20, may be needed to be exchanged. For example, if the liquid supply member is disposable, the liquid supply member is needed to be exchanged for each use. Or when the liquid supply member is worn off, it should be exchanged with a new one. Sometimes, depending on the purpose of the liquid supply, the liquid supply member is needed to be exchanged with another one with a different shape, a configuration, or a dimension.

The applicator 20 can be, if needed, exchanged with another one by disengaging the applicator 20 from the tip element 16. In this exchange, the liquid remained in the applicator 20 is also exchanged with the applicator 20, which improves the cleanliness and durability of the container. This is because, in this embodiment, due to the function of the piston advancing mechanism 23, the piston 22 is advanced forward, never backward, which prevents the liquid which once exited from the tank section T from flowing back into the tank section T.

Although in the above embodiment, the rotation of the rotating cam 30 in the rotating cam mechanism is transmitted to the piston rod guide 26 which is threadedly engaged with the piston rod 24, the rotation of the rotating cam 30 may be transmitted to the piston rod 24 to rotate the piston rod 24. In this case, the piston rod guide 26 may be fixedly provided on the tank section, so that the piston rod guide 26 is threadedly engaged with the piston rod 24 to operate in the same way.

FIG. 2 is a view of a second embodiment of the conventional liquid container. In FIG. 2, the same numerals are used to designate the same or similar parts in the first embodiment, the description of which will be omitted.

A container body 12 of a liquid container 10 in this embodiment includes a body case 44 to form a tank section T having a front end port 44a the diameter of which is smaller than that of the body case 44, and a tip element 16 that is integrally mounted on the outer circumference of the front end port 44a.

A piston advancing mechanism 50 has a piston rod 24 which has a front end coupled to a piston 22 and extends backward from the front end with a male thread 24a along the circumferential surface thereof, an operation cylinder 52 which is mounted to the rear portion of the body case 44, a piston rod guide 54 formed with a female thread bore 54c to be threadedly engaged with the male thread 24a of the piston rod 24, and a ratchet cylinder 56 fixed in the rear portion inside of the body case 44 through which the piston rod 24 passes. The operation cylinder 52 provides an operation member. Preferably as light play is provided axially between the piston rod 24 and the piston 22.

The operation cylinder 52 has an annular projection 52a which is formed on the front portion of the outer circumferential surface thereof. The annular projection 52a is fitted in an annular recess 44b which is formed in the rear portion of the inner circumferential surface of the body case 44 so that the operation cylinder 52 is mounted to the body case 44 rotatably relative to the body case 44. The operation cylinder 52 also has a plurality of longitudinal ribs 52c which are formed on the rear portion of the internal surface and project inward to provide a plurality of longitudinal grooves between the adjacent longitudinal ribs 52c. As shown in FIG. 10, the piston rod guide 54 has a longitudinal rib 54b at the rear end thereof, and the longitudinal rib 54b is fitted in the longitudinal grooves so that the operation cylinder 52 and the piston rod guide 54 integrally rotate.

In use of the liquid container 10 of the above structure, the cap 36 is removed and the liquid is applied with the applicator 20, and in order to supply more liquid through the applicator 20, the operation cylinder 52 is rotated relative to the body case 44.

Rotating the operation cylinder 52 relative to the body case 44 causes the piston rod guide 54 to rotate together, with the operation cylinder 52. On the contrary, since the piston rod 24 is fitted in the through bore 56e of the ratchet cylinder 56 which is fixed to the body case 44, and does not rotate, it causes a relative rotation between the piston rod guide 54 and the piston rod 24, and the engagement between a female threaded bore 54c of the piston rod guide 54 and a male thread 24a of the piston rod 24 allows the piston rod 24 to be advanced forward. As the piston 22 is advanced through the tank section T, a liquid L in the tank section T is forced toward the front end port 44a of the body case 44 to be supplied through the front end of the applicator 20 for use.

On the rotation of the operation cylinder 52, the serrations 52b of the operation cylinder 52 slide on the sloped surface of the ratchet tooth 56a provided on the ratchet cylinder 56 to make the ratchet tooth 56a retract and protrude to achieve a rotation. This retraction and protrusion of the ratchet tooth 56a produces a click sound which gives a user moderation. If a user tries to turn the operation cylinder 52 in a wrong opposite direction, the serrations 52b of the operation cylinder 52 and the ratchet tooth 56a of the ratchet cylinder 56 mate with each other to prevent a relative rotation so that the user cannot rotate the operation cylinder 52. Accordingly, the operation cylinder 52 is consistently rotated only in a direction in which the piston 22 is advanced through the tank section T. The piston 22 is advanced through the body case 44 in response to the consumed and decreased amount of the liquid L. If the operation cylinder 52 is accidentally rotated a small amount, the operation cylinder 52 possibly returns to its original position because the serrations 52a cannot pass over the ratchet tooth 56a. However, even in such a case, only the piston rod 24 retracts relative to the piston 22 and the piston 22 does not retract, which prevents the back flow of the liquid.

FIG. 3 is a view of a third embodiment of the conventional liquid container described in the above-identified publication. In the drawing, the same numerals are used to designate the same or similar parts in the second embodiment, the description of which will be omitted.

A liquid container 70 includes a container body 71 which comprises body case 72, an inner barrel 74 provided concentrically inside the body case 72 and rotatably with respect to the body case 72, a rear barrel 76 mounted to a rear end of the body case 72, and a tip element 78 mounted to the tip end of the body case 72, and a cap 79 detachably fitted on the tip element 78. An inside of the body case 72 and an inside of the inner cylinder 74 form a tank section T in which a liquid L for cosmetic, stationery, medical or oral care, etc, is housed. A cap 79 is detachably attached to the tip element 78 to protect the applicator 20 when it is not used.

An opening 72a is formed on a side surface of a tip end portion of the body case 72, a pushing member 80 for the user to manipulate is provided in the opening 72a, and the pushing member 80 is capable of projecting and retracting in an inward and outward direction of the body case 72.

A piston 100 is slidably disposed inside the tank section T, and a piston advancing mechanism for advancing the piston 100 is provided. The piton advancing mechanism has a pushing member 80 capable of projecting from and retracting into the body case 72 constructing the container body 71, a rotary member 90 on which the pushing member 80 directly works, an engaging member 92 placed on a front side of the rotary member 90, the inner cylinder 74, a rotation stopping member 94 provided at a rear end of the inner cylinder 74, an inside screw member 96 fixed to the body case 72, a piston rod 98 screwed into the inside screw member 96, a piston 100 connected to a tip end of the piston rod 98 and slidable inside the tank section T, and a return spring 102 (FIG. 13) as a biasing member for giving an urging force to the engaging member 92.

The inner cylinder 74 and the rotation stopping member 96 construct a transmitting member to which the rotation from the rotary member 90 is transmitted. The inner cylinder 74, the rotation stopping member 94, the inside screw member 96 and the piston rod 98 construct a conversion mechanism for converting the rotation of the rotary member 90 into a forward traveling motion of the piston 100 in the axial direction inside the body, and the engaging member 92 and the return spring 102 construct a rotation control mechanism for controlling a rotating direction of the rotary member 90.

While the above-mentioned conventional construction provides certain benefits and advantages, a need exists in the art for improvements thereto. More specifically, a need exists to improve the ergonomics of such dispensers, to improve the dispensing functionality and operation thereof, especially (but not exclusively) for such dispensers to be utilized in connection with dispensing dental materials.

### SUMMARY OF THE INVENTION

The present invention provides techniques and arrangements that can optionally address one or more of the abovementioned objectives.

“Dental materials” as used herein, is defined as any flowable material suitable for use in connection with dental care and/or maintenance. Such materials include, but are not limited to, adhesives, bleaching agents, fillers, holding materials, and the like.

According to one aspect, the present invention provides a dispenser comprising: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; and an advancing mechanism constructed and configured to move the ejection mechanism within the tank; wherein the body defines a proximal end of the dispenser, and the tip defines a distal end of the dispenser, at least the proximal end comprises a cross-section which differs from the cross-section of the remainder of the body and is configured to be easily grasped by a human hand.

According to another aspect, the present invention provides a dispenser comprising: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; an advancing mechanism constructed and configured to move the ejection mechanism within the tank; and an indicator disposed on the body configured to permit visual observation of the amount of flowable material contained in the tank.

According to a further aspect, the present invention provides a dispenser comprising: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; an advancing mechanism constructed and configured to move the ejection mechanism within the tank, the advancing mechanism comprising at least one of a button, slider or circumferential sleeve accessible along the lateral side of the body for advancing the ejection mechanism within the tank.

According to yet another aspect, the present invention provides a dispenser comprising: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; and an adjustable mechanism for selectably controlling or limiting the amount of flowable material dispensed.

According to an additional aspect, the present invention provides a dispenser comprising: a body, at least a portion of the body being substantially cylindrical; a tank constructed and configured to contain a flowable material; a tip, the tip comprising an opening through which the flowable material is dispensed; an ejection mechanism constructed and configured to urge the flowable material from the tank through the opening in the tip; and an advancing mechanism constructed and configured to move the ejection mechanism within the tank; wherein the tank is constructed and configured to be refilled with flowable material without being separated from the body of the dispenser.

According to still a further aspect, the present invention provides, in combination, a dispenser as described above and a refilling well and holder, the refilling well and holder comprises a reservoir of the flowable material for replenishing the flowable material to the tank of the dispenser, the refilling well and holder comprises an opening constructed and configured to receive at least a portion of the body of the dispenser therein.

According to another optional aspect of the present invention, there is provided a dispenser comprising: a body, at least a portion of the body being substantially cylindrical; a removable cartridge comprising a tank constructed and configured to contain a flowable material; a tip, the tip comprising an opening through which the flowable material is dispensed; an ejection mechanism constructed and configured to urge the flowable material from the tank through the opening in the tip; and an advancing mechanism constructed and configured to move the ejection mechanism within the tank.

According to a further alternative, the present invention may optionally include a dispenser comprising: a body, at least a portion of the body being substantially cylindrical; a tank constructed and configured to contain a flowable material; a tip, the tip comprising an opening through which the flowable material is dispensed, the tip of further comprising a cannula constructed and configured to direct the flow of the dispensed material; an ejection mechanism constructed and configured to urge the flowable material from the tank through the opening in the tip; and an advancing mechanism constructed and configured to move the ejection mechanism within the tank.

According to a further aspect, the present invention provides, in combination, a dispenser as defined above and a docking station, the docking station having a first engagement formation constructed and configured to receive at least the cannula portion of the dispenser therein and provide a mating interaction therewith which releases at least a cannula portion from the dispenser.

The present invention can also provide, in combination, a dispenser as defined above, and a dental material disposed in the tank thereof.

### BRIEF DESCRIPTION OF THE DRAWING FIGURES

FIG. 1 is a composite cross-sectional view of a conventional dispenser construction.

FIG. 2 is a composite cross-sectional view of an alternative embodiment of a conventional dispenser construction.

FIG. 3 is a cross-sectional view of a further alternative embodiment of the conventional dispenser construction.

FIG. 4 is a sectional/cut away view of a dispenser constructed according to certain aspects of the present invention.

FIG. 5 is a sectional view illustrating certain features of the advancing mechanism of the dispenser of FIG. 4.

FIG. 6 is a perspective view of a dispenser formed according to further aspects of the present invention.

FIG. 7 is a perspective view of a dispenser formed according to further embodiments of the present invention.

FIG. 8 is a perspective view of a dispenser formed according to additional aspects of the present invention, in combination with a refilling well.

FIG. 9 is a perspective view of further alternative aspects of a dispenser formed according to the principles of the present invention.

FIG. 10 is a perspective view of one optional modification of the dispenser illustrated in FIG. 9.

FIG. 11 is a perspective view of a further optional modification of the dispenser illustrated in FIG. 9.

FIG. 12 is a sectional view of a dispenser in combination with a docking station according to further alternative embodiments of the present invention.

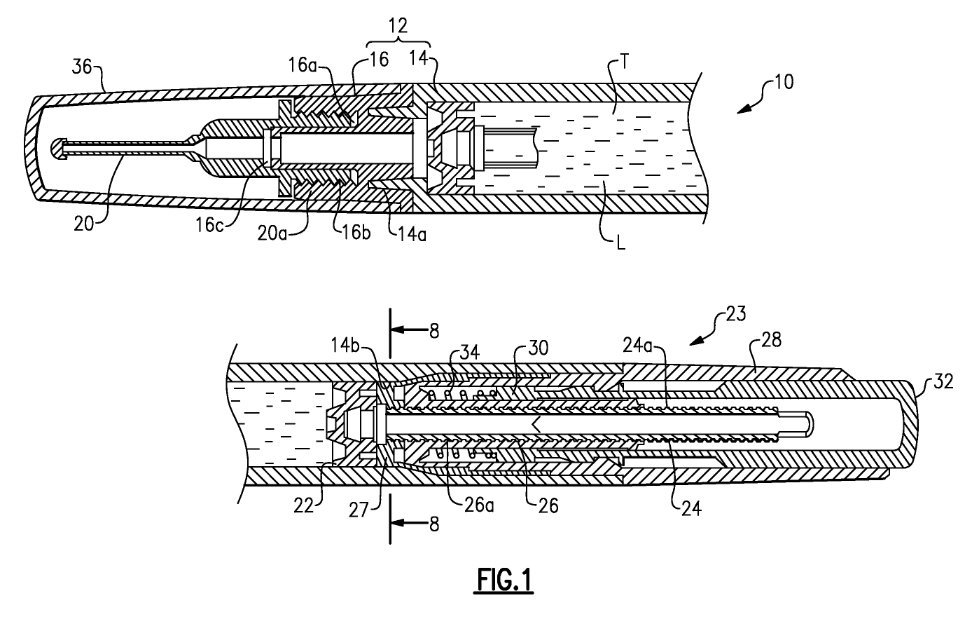

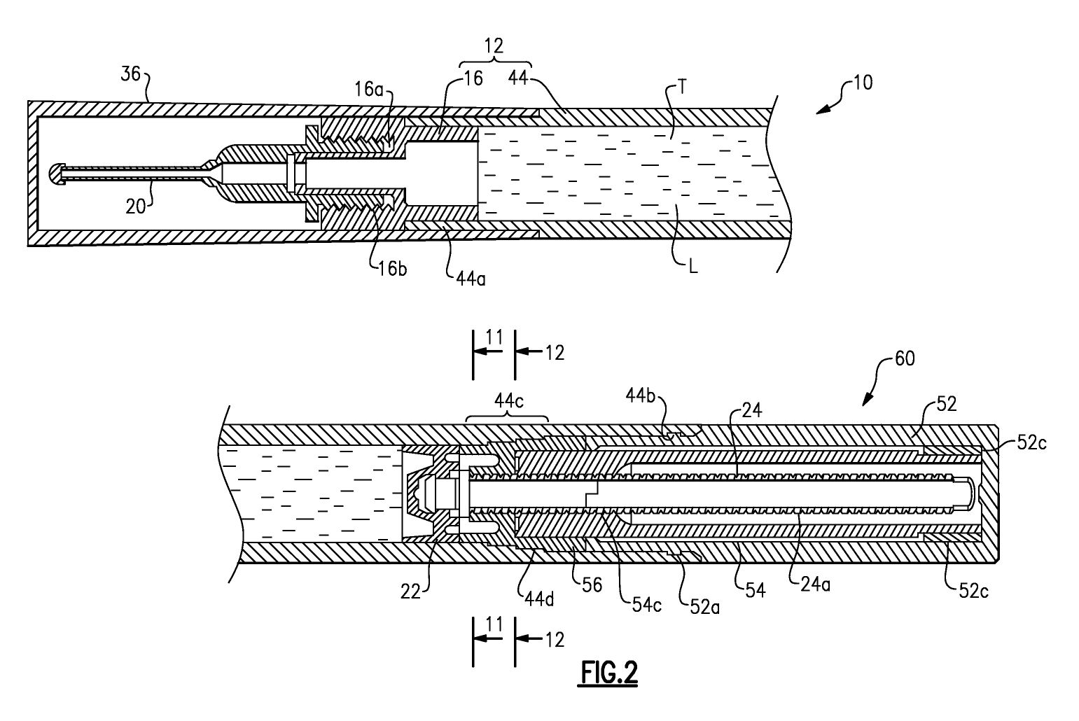

### DETAILED DESCRIPTION OF THE INVENTION

Generally, a dispenser constructed according to certain embodiments of the present invention may include any feature, or any combination of features, of the dispenser described in the above referenced U.S. Patent Application Publication No. US2007/0086830. The dispenser of the present invention is of course not limited to this construction, and may comprise a general construction having features other than those described in the above-mentioned Publication. Regardless of the fundamental configuration, a dispenser constructed according to the principles of the present invention can have at least one, or any combination of, the following features:

Design
More ergonomic and more sophisticated design (must rest better in the hand (e.g., toothbrush).
Pen longer/wider towards the rear
Hand rest
Should stand presentably on the plate
Cap should be clip-on to attach to the far end of the pen

Haptics
Various degrees of rubber hardness, just like with toothbrushes
Rubber coat covering the click mechanism
Improved haptics of the pushbutton

Pushbutton
Pushbutton should be found blind—possibly new material
Slider instead of pushbutton
Lateral circumferential operation mechanism
Ergonomic grip coating

Level indicator
Orange viewing window
Same as hydroponics
Entire pen orange
LC display
Colored LEDs
Transparent
Red threaded spindle with viewing window
“Indicator” is pressed through the nozzle (pushed forward by a rubber)
Blockage/distinguishing mark when empty

Adapter with arrow (OK marking on adapter)
Manually adjustable extrusion quantity/lift variation (insulin pen) (e.g., by rotating the rear part of the pen)
Electrically adjustable extrusion quantity/on/off switch for individual dosage
Transport of the material same as in a fountain pen (transport upon use/brushing in)
Adapter+cannula=1 item, immediately positionable in the right way

Cannula
Thicker cannula
Snap-fit cannula
Click-on cannula
Springy cannula
Longer cannula flock coating with wider cannula openings
Colored flock coating
Brush changes the color as soon as the material starts wetting
Sponge instead of flock coating

Easy change of cannula
Click/push of a button—the cannula drops off (like, e.g., Eppendorf pipettes)
Reservoir with cannulas
Click-on cannulas
Pen holder (with cover)

Two-sided use
Luer Lock
Mirror
Two components (Caution: risk of dripping)
Suction cup to secure the pen on the table/at the wall etc.
Cartridge with compressed air
Children's pen for fissure sealings: Click-on comic head

Disinfectability of the pen
Semi-critical A—without edges or grooves
Rubber coat covering the click mechanism
Self-disinfecting material/plastic coating

Refillable pen—Cartridge
Cartridge
Refilling station (e.g., ink well)
As with a fountain pen with a spherule
Puncturing the rubber seal and attached nozzle
Nozzle and adapter are components of the cartridge
Single-dose cannula

Timer
Cartridge codable for time
Signal
Name of the product
Timer/LED to green

Vibrating Pen

Specific illustrative non limiting embodiments of the present invention will now be described by reference to the drawing figures. The same reference numerals have been repeated in the various figures, where appropriate, to identify common features which reappear in the various illustrated embodiments.

FIG. 4 illustrates a dispenser 120 formed according to certain aspects of the present invention. As evident from the illustration, the dispenser 120 can take the general form of a pen-like device sized and configured to be easily grasped by the human hand. The dispenser 120 is of course not limited to the particular form illustrated in FIG. 4.

The dispenser 120 comprises a body portion 122. At least a portion of the body 122 can optionally be substantially cylindrical. The body portion 122 contains and/or defines a tank 124 for holding a flowable material to be dispensed. Numerous flowable materials are contemplated. According to certain embodiments, the flowable material can comprise a dental material.

The dispenser 120 may further include an ejection mechanism 126 for urging the flowable material within the tank in a particular direction, such as the case when the flowable material in the tank is ejected therefrom and dispensed. Numerous ejection mechanisms are contemplated. According to the illustrated embodiment, the ejection mechanism 126 comprises a linearly movable piston-type device.

A tip 128 can be provided at one end of the dispenser 120. An opening 130 is provided to permit ejection of the flowable material from the tank 124. According to the illustrated embodiment, the tip 128 further includes a cannula 132 which is constructed and configured to facilitate application or placement of the flowable material which is dispensed from the device. The cannula 132 can take numerous forms. For example, the cannula 132 can comprise a sponge-like material, a flock coating, may include a brush, and/or may be flexible in one or more directions.

An advancing mechanism 134 may be provided which is accessible to the user of the dispenser 120 and causes the ejection mechanism 126 to move within the tank 124 thereby ejecting the flowable material contained therein. Numerous advancing mechanisms are contemplated. The advancing mechanism 134 may comprise one or more of a pushbutton, slider, or circumferential sleeve. According to the illustrated embodiment, the advancing mechanism 134 comprises a circumferential sleeve 136. According to certain optional embodiments, a circumferential sleeve 136 can either be formed from, or coated with, a grip-enhancing material, such as rubber or a rubber-like material. According to further optional embodiments, a pushbutton, slider, or circumferential sleeve of the advancing mechanism 134 may be formed from, or coated with, a material having anti-microbial properties.

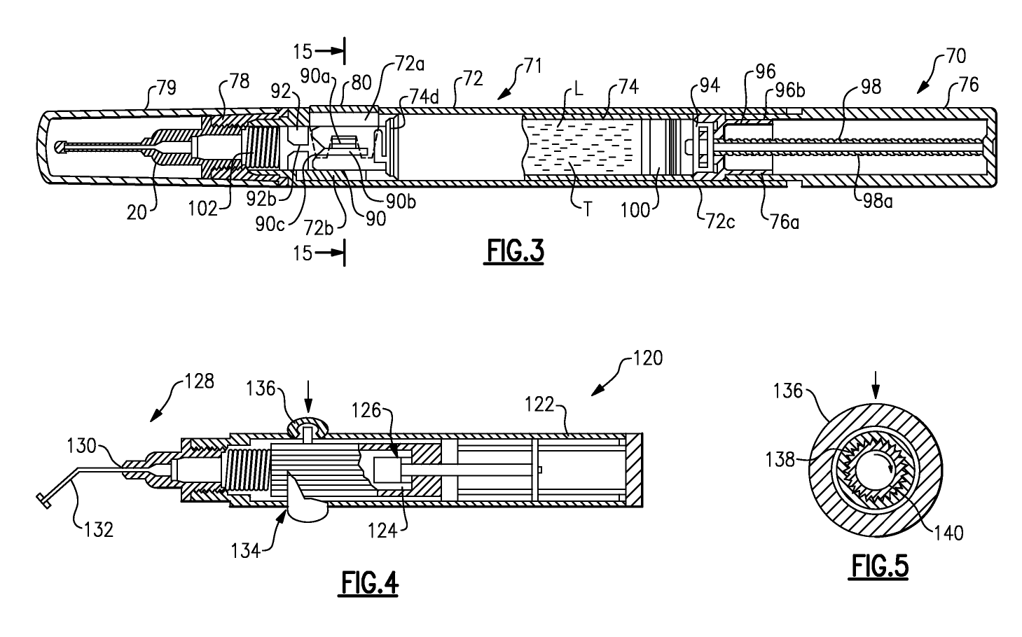

As perhaps best illustrated in FIG. 5, the advancing mechanism 134 of the illustrated embodiment includes a plurality of radially directed members 138 having at least one end operatively associated with a circumferential sleeve 136. The plurality of radially directed members 138 are operatively associated with a rotatable member 140 at a second end thereof. Thus, application of a generally radially-directed force to the circumferential sleeve 136 is transmitted via the generally radially directed members 138 to the rotatable member 140 and causes rotational movement of the rotatable member 140, as seen in FIG. 5. This rotational movement of the rotatable member 140 is in turn used to drive the ejection mechanism 126. According to the illustrated embodiment, the rotational movement of the rotatable member 140 is translated into linear motion of the piston-like device within the tank 124.

As a general principle, it is contemplated that modifications to one or more features of the dispenser may be necessary or desirable. For example, when the flowable material to be dispensed has a relatively high viscosity, it may be necessary or desirable to: (1) increase the inner diameter of the opening 130, and the inner diameter of the cannula 132 (if present); and/or (2) increase the pressing force applied by the ejection mechanism. This design consideration applies to all embodiments of the present invention.

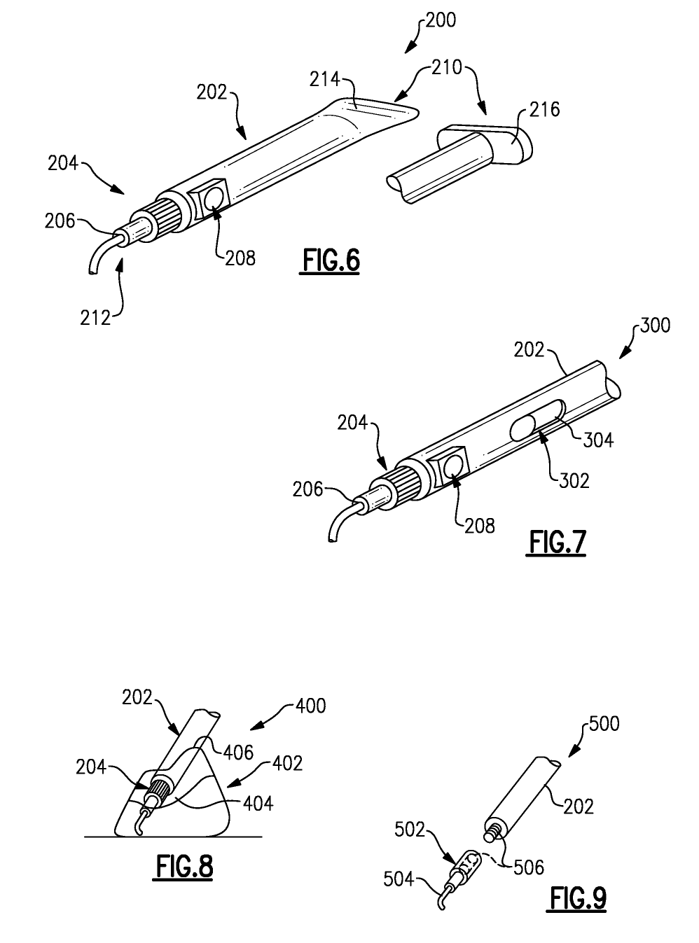

FIG. 6 is illustrative of a dispenser 200 formed according to further embodiments of the present invention. According to the illustrated embodiment, the dispenser 200 can be generally pen-like in form. The dispenser 200 may comprise a body 202. At least a portion of the body 202 can be substantially cylindrical. A tank and an ejection mechanism may be contained within, or defined by, the body 202 (not shown). The tank and ejection mechanism can take any suitable form, such as that described in connection with the previous embodiment discussed above, or as described in connection with the conventional dispenser construction of the above identified Publication.

The dispenser 200 may further comprise a tip 204. The tip 204 defines an opening 206 which permits the ejection of the flowable material therefrom. An advancing mechanism 208, which may include a pushbutton type construction, may also be provided.

As further illustrated in FIG. 6, the body 202 of the dispenser 200 defines a proximal end 210 opposite the tip 204. The dispenser 200 further includes a distal end 212 opposite the proximal end 210. According to the illustrated embodiment, the dispenser 200 is provided with a feature at the proximal end 210 which improves the ergonomics of the dispenser 200 by facilitating grasping thereof by human hand. Numerous features of this type are contemplated. As illustrated in FIG. 6, a substantially flattened cross-section 214 can be provided at the proximal end 210 for this purpose. Alternatively, as further illustrated in FIG. 6, an enlarged shoulder-like end formation 216 can be provided at the proximal end of 210 to facilitate handling of the dispenser 200.

FIG. 7 is illustrative of a further alternative embodiment of a dispenser formed according to the principles of the present invention. The dispenser 300 illustrated therein generally comprises a number of features in common with the previously described embodiment, as evidenced by the use of the same reference numerals utilized in connection with the description of the previous embodiment of FIG. 6. The description of these features is incorporated herein by reference to the description of the previous embodiment.

As illustrated in FIG. 7, the dispenser 300 includes an indicator 302 provided on the body 202 for purposes of indicating the level of flowable material contained within the tank. A number of different indicators 302 are contemplated for this purpose. According to the illustrative example, the indicator 302 comprises a transparent, or substantially transparent window 304 which permits an observation of the flowable material contained in the tank of the dispenser 300. Contemplated alternatives, or additions to, to the transparent or substantially transparent window 304 include: a digital display having an alphanumeric readout; and LCD display having either an alphanumeric or graphic readout; a plurality of colored LEDs, wherein the colors are representative of the level of flowable material contained in the tank; a colored (e.g., red) threaded spindle with a viewing window; and indicator configured to be pressed in through the opening of the tip and into the tank.

FIG. 8 illustrates a dispenser 400 formed according to an alternative embodiment of the present invention that includes a tank that is refillable with flowable material without resorting to separation of the tank from the remainder of the dispenser. Thus, according to this embodiment, the dispenser 400 functions, and at least in this respect, in a manner which is somewhat analogous to a fountain pen. The dispenser 400 may be utilized in conjunction with a refilling well 402 which includes a reservoir 404 for the flowable material. When the dispenser 400 is inserted into the refilling well 402 a suitable construction is provided within the dispenser 400 for permitting the flowable material to enter the tank, such as one or more passageways which communicate between the reservoir 404 and the tank upon insertion of the dispenser 400 into the opening 406 of the refilling well.

FIG. 9 illustrates a further optional embodiment of the dispenser 500 formed according to the principles of the present invention. As illustrated therein, the dispenser 500 includes an adapter 502 defining a tip portion of the dispenser 500. The adapter 502 is removably connected to the body 202 of the dispenser 500. The adapter 502 optionally includes a cannula 504. According to the illustrated embodiment, the removable connection between the body 202 and the adapter 502 is provided by a threaded connection 506, wherein a mating set of screw threads are provided on the body 202 and the adapter 502.

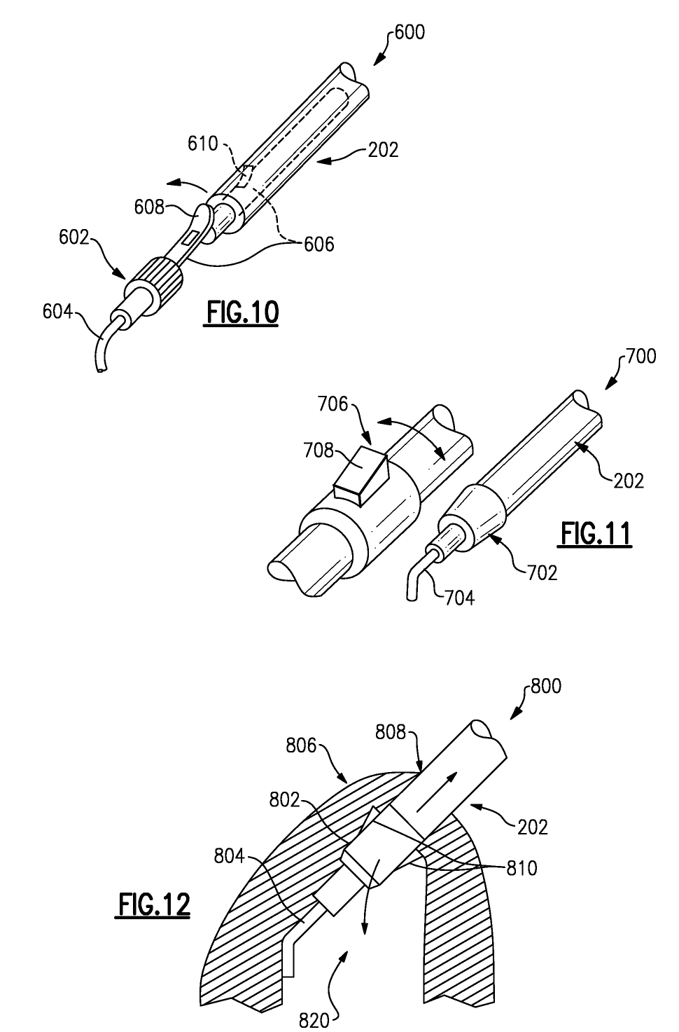

FIG. 10 is illustrative of a further embodiment of the present invention, which represents a modification of the previously described embodiment of FIG. 9. According to the embodiment illustrated in FIG. 10, the dispenser 600 comprises an adapter 602 which is removably connected to the body 202 of the dispenser 600. The adapter 602 optionally comprises a cannula 604. The adapter 602 is connected to the body 202 via a removable connection 606, which in this embodiment, includes a flexible spring-like finger 608 which includes an aperture or slot therein, and a mating retaining projection 610 provided on the body 202 of the dispenser 600.

FIG. 11 is illustrative of yet another embodiment of the present invention, which represents a modification of the two previously described embodiments of FIGS. 9 and 10. As illustrated therein, the dispenser 700 includes an adapter 702, which optionally comprises a cannula 704. The adapter 702 is removably connected to the body 202 of the dispenser 700 via a releasable connection 706. According to this embodiment, the releasable connection 706 generally comprise a projection or hump 708 provided on the adapter 702. The adapter 702 may have a friction fit over the body 202 of the dispenser 700. The hump or projections 708 may simply provide a suitable abutment for pushing the adapter 702 off of the body 202. In this instance, the pushing force can be either generally axial, or generally circumferential, as illustrated in FIG. 11. Alternatively, the projection or hump 708 can be substantially hollow, and a corresponding projection provided on the body 202 may be received therein. The projection or hump 708 may be movable generally the radial direction thereby releasing the connection between the body 202 in the adapter 708 upon pressing by a user.

FIG. 12 is illustrative of yet another alternative embodiment of the present invention. According to this optional embodiment, the dispenser 800 also includes an adapter 802 removably connected thereto. The adapter 802 may optionally comprise a cannula 804. A docking station 806 can be provided in combination with the dispenser 800. The docking station 806 can comprise at least one opening 808 formed therein for receiving at least the adapter portion 802 of the dispenser 800 therein. The opening 808 is configured to receive the adapter 802, and interact therewith, in a manner which releases it from the body 202 of the dispenser 800. For example, the opening 808 can be shaped such that one or more release projections 810 located on the adapter 802 are pressed inwardly enough to cause the adapter 802 to be separated from the body 202 of the dispenser 800. The docking station 806 may further comprise a holding area 820 for receiving used adapters once they have been separated from the body 202 of the dispenser 800. According to further alternative constructions, the holding station may also be provided with a supply of new, unused replacement adapters for connection to the body 202 of the dispenser 800. At least one additional opening and/or compartment may be provided for this purpose (not shown).

All numbers expressing quantities or parameters used in the specification are to be understood as additionally being modified in all instances by the term “about”. Notwithstanding that the numerical ranges and parameters set forth, the broad scope of the subject matter presented herein are approximations, the numerical values set forth are indicated as precisely as possible. For example, any numerical value may inherently contain certain errors, evidenced by the standard deviation associated with their respective measurement techniques, or round-off errors and inaccuracies.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A dispenser comprising:
a body, at least a portion of the body being substantially cylindrical;
a tank constructed and configured to contain a flowable material;
a tip, the tip comprising an opening through which the flowable material is dispensed;
an ejection mechanism constructed and configured to urge the flowable material from the tank through the opening in the tip; and
an advancing mechanism constructed and configured to move the ejection mechanism within the tank;
wherein the body defines a proximal end of the dispenser, and the tip defines a distal end of the dispenser, at least the proximal end comprises a cross-section which differs from the cross-section of the remainder of the body and is configured to be easily grasped by a human hand.

2. The dispenser of claim 1, wherein the cross-section of the proximal end is substantially flattened relative to the cross-section of the remainder of the body.

3. A dispenser comprising:
a body, at least a portion of the body being substantially cylindrical;
a tank constructed and configured to contain a flowable material;
a tip, the tip comprising an opening through which the flowable material is dispensed;
an ejection mechanism constructed and configured to urge the flowable material from the tank through the opening in the tip;
an advancing mechanism constructed and configured to move the ejection mechanism within the tank; and
an indicator disposed on the body configured to permit visual observation of the amount of flowable material contained in the tank.

4. The dispenser of claim 3, wherein the indicator comprises a window of transparent or substantially transparent material.

5. The dispenser of claim 4, wherein the transparent or substantially transparent material is orange in color.

6. The dispenser of claim 3, wherein the indicator comprises a digital display.

7. The dispenser of claim 6, wherein the display comprises an LCD display.

8. The dispenser of claim 6, wherein the display comprises colored LEDs.

9. The dispenser of claim 3, wherein the indicator comprises a red threaded spindle with a viewing window.

10. The dispenser of claim 3, wherein the indicator is configured to be pressed in through the opening of the tip and into the tank.

11. A dispenser comprising:
a body, at least a portion of the body being substantially cylindrical;
a tank constructed and configured to contain a flowable material;
a tip, the tip comprising an opening through which the flowable material is dispensed;
an ejection mechanism constructed and configured to urge the flowable material from the tank through the opening in the tip;
an advancing mechanism constructed and configured to move the ejection mechanism within the tank, the advancing mechanism comprising at least one of a button, slider or circumferential sleeve accessible along the lateral side of the body for advancing the ejection mechanism within the tank.

12. The dispenser of claim 11, wherein the advancing mechanism comprises a circumferential sleeve, the advancing mechanism further comprises generally radially directed members operably connected to the sleeve, and a rotatable member operably connected to the radially directed members, wherein upon application of a radial force to the circumferential sleeve, the radially directed members engage and produce rotary movement of the rotatable member which in turn is translated to the ejection mechanism for urging the flow of material from the tank and through the opening in the tip.

13. The dispenser of claim 11, wherein the button, slider or circumferential sleeve is formed from, or is coated with, a rubber-like material.

14. The dispenser of claim 11, wherein the button, slider or circumferential sleeve is formed from, or is coated with, a self-disinfecting or antimicrobial material.

15. A dispenser comprising:
a body, at least a portion of the body being substantially cylindrical;
a tank constructed and configured to contain a flowable material;
a tip, the tip comprising an opening through which the flowable material is dispensed;
an ejection mechanism constructed and configured to urge the flowable material from the tank through the opening in the tip;
and an adjustable mechanism for selectably controlling or limiting the amount of flowable material dispensed.

16. The dispenser of claim 15, wherein the adjustable mechanism comprises a rotatable member associated with the body of a dispenser for selectively controlling the amount of flowable material dispensed.

17. The dispenser of claim 15, wherein the adjustable mechanism comprises an electrically operable switch mechanism for selectively controlling the amount of flowable material dispensed.

18. A dispenser comprising:
a body, at least a portion of the body being substantially cylindrical;
a tank constructed and configured to contain a flowable material;
a tip, the tip comprising an opening through which the flowable material is dispensed;
an ejection mechanism constructed and configured to urge the flowable material from the tank through the opening in the tip; and
an advancing mechanism constructed and configured to move the ejection mechanism within the tank; wherein the tank is constructed and configured to be refilled with flowable material without being separated from the body of the dispenser.

19. In combination, the dispenser of claim 18 and a refilling well and holder, the refilling well and holder comprises a reservoir of the flowable material for replenishing the flowable material to the tank of the dispenser, the refilling well and holder comprises an opening constructed and configured to receive at least a portion of the dispenser therein.

20. A dispenser comprising:
a body, at least a portion of the body being substantially cylindrical;
a removable cartridge comprising a tank constructed and configured to contain a flowable material;
a tip, the tip comprising an opening through which the flowable material is dispensed;
an ejection mechanism constructed and configured to urge the flowable material from the tank through the opening in the tip; and
an advancing mechanism constructed and configured to move the ejection mechanism within the tank.

21. The dispenser of claim 20, wherein the cartridge comprises a source of compressed air.

22. The dispenser of claim 20, wherein the cartridge comprises a pierceable seal constructed and configured to be ruptured by a piercing member which forms part of the tip when the tip is attached to the cartridge.

23. The dispenser of claim 20, wherein the cartridge further comprises a nozzle and an adapter constructed and configured to be received by the body of the dispenser.

24. The dispenser of claim 20, wherein the cartridge is codable for time.

25. The dispenser of claim 20, wherein the cartridge comprises a signal-producing component.

26. The dispenser of claim 20, wherein the cartridge comprises a timer operably connected to an LED.

27. A dispenser comprising:
a body, at least a portion of the body being substantially cylindrical;
a tank constructed and configured to contain a flowable material;
a tip, the tip comprising an opening through which the flowable material is dispensed, the tip of further comprising a cannula constructed and configured to direct the flow of the dispensed material;
an ejection mechanism constructed and configured to urge the flowable material from the tank through the opening in the tip; and
an advancing mechanism constructed and configured to move the ejection mechanism within the tank.

28. The dispenser of claim 27, wherein the cannula is provided with a snap-fit connection to the body of the dispenser.

29. The dispenser of claim 27, wherein the cannula is provided with a flock coating or is formed from a sponge-like material.

30. The dispenser of claim 27, wherein the cannula is at least partially flexible and/or resilient.

31. The dispenser of claim 27, wherein at least a portion of the cannula changes color upon contact with the flowable material.

32. The dispenser of claim 27, wherein the cannula forms part of an adapter which is removably attachable to the body of the dispenser.

33. The dispenser of claim 32, wherein the adapter is provided with a snap-fit connection with the body of the dispenser.

34. The dispenser of claim 33, wherein a snap that connection comprises a push-button type release mechanism.

35. The dispenser of claim 34, wherein the push-button type release mechanism is constructed and configured to be operable with a single human hand.

36. The dispenser of claim 27 in combination with a docking station, the docking station having a first engagement formation constructed and configured to receive at least the cannula or adapter portion of the dispenser therein and provide a mating interaction therewith which releases at least a cannula or adaptor portion from the dispenser.

37. The combination of claim 36, wherein the docking station further comprises an area for holding the released cannula or adapter portion.

38. The combination of claim 36, further comprising a second engagement formation constructed and configured to hold a replacement cannula or adapter portion and to attach a new cannula or adapter portion to the dispense upon interaction with the second engagement formation.

39. The dispenser of claim 27 comprising a dental material disposed in the tank thereof.
